(19) United States
(12) Patent Application Publication
(10) Pub. No.: US 2010/0184588 A1
(43) Pub. Date: Jul. 22, 2010

(54) METHODS OF MAKING CATALYTIC MATERIALS BY DISPERSION OF NANOPARTICLES ONTO SUPPORT STRUCTURES

(75) Inventor: Fabrizio RINALDI, Jackson, MI (US)

Correspondence Address: KNOBBE MARTENS OLSON & BEAR LLP, 2040 MAIN STREET, FOURTEENTH FLOOR, IRVINE, CA, 92614, US

(73) Assignee: QUANTUMSPHERE, INC., Santa Ana, CA (US)

(21) Appl. No.: 12/687,795

(22) Filed: Jan. 14, 2010

Related U.S. Application Data
(60) Provisional application No. 61/145,485, filed on Jan. 16, 2009.

(51) Int. Cl. B01J 23/00; B01J 29/00; B01J 21/16; B01J 21/04; B01J 23/10; B01J 21/06; B01J 21/08; B01J 23/02; B01J 31/02

(52) U.S. Cl. 502/80; 502/100; 502/60; 502/355; 502/304; 502/349; 502/232; 502/350; 502/150; 977/773

(57) ABSTRACT

Methods are disclosed herein for improving efficient catalyst utilization in processes including thermal catalysis using dry nanoparticle promoters, rather than salts of metal promoters in liquid form. Using selected process steps, the nanoparticles are more controllably dispersed on primary support particles, for effective use on secondary supports when it desired to bring reactants into contact with the secondary support. Applications that generally make use of these catalysts can be but are not limited to: emission abatement catalysts, generation of syngas, generation of liquid fuels from syngas, safety systems (hydrogen recombination catalysts in nuclear power plants) and many industrial processes.

### BACKGROUND

1. Technical Field

This disclosure relates generally to catalytic processes, such as thermocatalysis, for the transformation of reactants and/or the reduction of reactants, and, more specifically, this disclosure relates to a process for increasing efficient catalyst utilization.

2. Related Art

Thermocatalysis usually employs a promoter supported on a high surface area support material. A promoter is metal or metallic element which increases the rate of a chemical reaction. The overall goal is to create alternative reaction pathways that have lower activation energy and thereby promote a more efficient reaction scheme. Applications that generally make use of these catalysts can be, for example, emission abatement catalysts (used, for example, in volatile organic compound (VOC) reduction, NOx reduction, particulate matter (PM) reduction, and ozone abatement); generation of syngas (comprising CO and H₂) from a variety of feedstocks; generation of liquid fuels (such as octane, diesel, alcohols, DME, and JP8) from syngas; safety systems, such as hydrogen recombination catalysts in nuclear power plants; and many industrial processes (Born-Haber, synthesis of terephthalic acid, pharmaceutical intermediates, herbicides, pesticides, etc.).

In prior art methods, promoters are usually introduced on or into support particles by a method known as incipient wetness impregnation. This method involves exposing the support particles to a metal salt solution followed by chemical reduction to precipitate promoter particles. After further chemical processing, drying, and calcination, the promoter is found to be bonded either at the surface of the support particles or within the pore structure of the particles.

In some cases, where the support particles includes internal pores, it may be more advantageous to exclude as much of the promoter from the internal pores as possible. In other cases, it many be more advantageous to situate a greater percentage of the promoter within the pores, rather than on the outside of the support particles. One disadvantage of incipient wetness impregnation, however, is that control of particle size and location on the support particles is more difficult. Catalyst utilization is thus not maximized because a large portion of the reactants may never come into contact with promoters. For that reason, prior techniques do not provide the most efficient use of promoters.

### SUMMARY

Aspects of the present invention address some of the limitations of prior processes by making use of an already fixed and discretely sized nanoparticle promoter dispersed onto primary support particles, which may then optionally be applied to a secondary macro-support, such as a monolithic substrate. The nano-sized promoter may comprise a pure metal, metallic element, or an alloy, with or without a core-shell structure. Using at least some of the embodiments described below, these dry nanoparticle promoters can be controllably introduced in a desired location in the primary support particles (e.g., on the surface of the support particles and/or within internal pores). Nanoparticle promoters placed onto support particles are defined as “catalysts.” Catalyst may then be fixed to a secondary support by mechanical and/or thermal processes. In various embodiments, methods of impregnating dry nanoparticle promoters into and onto primary support particles comprise using a selected promoter dispersion. The composition of the promoter dispersion, as well as particle size distribution, allows improved control of the location of the nanoparticle promoter on and in the support particles. At least one commercial benefit is simplified processing, the potential to reduce the use of or eliminate precious metals, and higher catalyst efficiency, utilization, and durability.

In various embodiments, a process for physical (non-chemical reduction) dispersion of nanoparticle promoters in or on thermocatalyst support particles is described herein. The process can comprise selecting a particle size distribution and chemistry of the nanoparticle promoter; selecting a dispersing agent (such as a wetting agent and/or surfactant) to keep one or more nanoparticle promoters dispersed within a bulk carrier medium and/or control placement of the promoter onto selected sites of the support particles; selecting a carrier medium that has desirable properties (e.g., proper surface tension, non-reactive with promoter and support) to permit combining the nanoparticle promoter with the dispersion agent and carrier to form a promoter dispersion; creating a slurry by combining the promoter dispersion to the support particles so as to achieve selective positioning of the nanoparticle promoter on the support; the combining occurring, for example, by adding the support particles to the promoter dispersion, adding the promoter dispersion to the support particles, or simultaneously adding both; drying the slurry within a selected temperature range to remove the carrier medium; and calcinating the catalyst within a selected temperature range to remove any leftover carrier medium/wetting agent, and to fix the dispersed promoter onto a selected site of the support. The application of the catalyst dispersion onto a secondary (macro) support structure may be achieved by applying the wet slurry prior to calcination or be reconstitution of the calcinated slurry with water and coating the secondary support.

The process may be such that the dispersing agents comprise one or more of the following families of chemical reagents or mixtures in various proportions: silanes, siloxanes, alcohols, glycols, esters, ethers, and hydrocarbons. Preferably, tri-methyl siloxane, polyethylene glycol (PEG), polyethylene oxide monoallyl ether, methyl(propylhydroxide, ethoxylated) bis(trimethylsiloxy)silane, as well as various substituted silanes and siloxanes are used.

The process may be such that the carrier medium is configured to create an overall synthesis environment that is conducive to keeping the nanoparticle promoter at its primary phase or enhancing the formation of its equivalent oxide, and aiding the dispersion of the nanoparticle promoters for effective introduction into or onto support particles. The process may be such that the carrier medium comprises water, alcoholes, ketones, hexanes, olefins or a mixture thereof

Preferably, the support particles have a high surface area. Examples of suitable support particles may be, but are not limited to, alumina, ceria, zirconia, zeolites, silicas, perovskites, pillared clays, metal organic frameworks, and combinations thereof. The support particles can be in the form of a powder. Preferably, the support particles have average pore diameters in the range 0.2 nm to 50 nm. The process may further comprise initially fixing the nanoparticle promoter by means of high shear mixing via bead mixer, ultrasound or similar technique, with a process time ranging between 5 minutes and 2 hours, depending upon quantity and concentration. The process may further comprise finally fixing of the nanoparticle promoter onto the support particles by thermal means in the range of about 400° C. to 600° C. for about 1 to 6 hours, depending upon promoting metal specie, quantity and overall position of the promoting metal particle on the support particles.

### BRIEF DESCRIPTION OF THE DRAWINGS

FIG. 1 is a flow chart schematically showing dispersion synthesis according to at least one embodiment described herein.

FIG. 2 is a flow chart schematically showing catalyst synthesis according to at least one embodiment described herein.

FIG. 3 is a flow chart schematically showing preparation of catalyst on a secondary support, according to at least one embodiment described herein.

FIG. 4 compares the reactivity of a catalyst according to at least one embodiment versus a commercially available catalyst.

FIG. 5 illustrates the reactivity and stability of a catalyst according to at least one embodiment in a methane oxidation reaction.

The features mentioned above in the summary, along with other features of the inventions disclosed herein, are described below with reference to the drawings. The illustrated embodiments in the figures listed below are intended to illustrate, but not to limit, the inventions.

### DETAILED DESCRIPTION

At least one embodiment of the present invention comprises combining a nanoparticle promoter, in the form of dry nano-sized metal or metallic particles suitable for catalysis, with a dispersion agent in a weight ratio of about 10% to 15% promoter. The disclosed dispersion method enhances catalytic efficiency in thermocatalytic applications.

Using one of numerous methods of manufacture, it is possible to generate nanoparticle promoters that have beneficial use in improving the efficiency of chemical reactions. It should be acknowledged that there are many techniques for preparing the dry nanoparticle promoters, although the preferred methodology is described in U.S. Pat. No. 7,282,167 to Carpenter, the contents of which is incorporated herein in its entirety by reference. Applications of such preferred catalytic material are described in U.S. application Ser. No. 11/482,290 filed Jul. 7, 2006 and Ser. No. 11/781,909 filed Jul. 23, 2007, the contents of both of which are incorporated herein in their entireties by reference. Preferably using the process of the '167 Patent to Carpenter, the catalytic material may be more uniform in size, and therefore, catalytic effectiveness. Elements suitable for use as promoters may be elements selected from groups 4, 6, 7, 8, 9, 10, 11, 12, and lanthanides on the periodic table. Preferably, the elements Pt, Pd, Rh, Ag, Au, Co, Mn, Fe, Cu, Ni, Ti, Zr, La, Cr Nd, Mo, W, Sn, Zn, Cr Ru, alloys thereof, and oxides thereof are suitable for use a promoters.

The particle size distribution of the nanoparticle promoter should be selected to either facilitate or prevent adsorption of the promoter into the support pore. This selection is also dependent on the desired thermochemical reaction. For example, in a NOx reduction reaction, it is desirable that one or more nanoparticle promoters such as palladium and nickel nanoparticles be adsorbed on the exterior surface of the support particles versus in the pores. As such, the nanoparticle promoter size would be selected such that the particle is larger than the support pore diameter. In another example reaction, such as hydrocarbon oxidation, it is desirable that one or more nanoparticle promoters be adsorbed in the pores versus on the exterior surface. As such, the nanoparticle promoter size would be selected such that the particle is would size smaller than the support pore diameter.

In a reaction such as syngas to fuel, also generally known as Fischer-Tropsch, one or more nanoparticle promoters could be selected such that certain promoters could be adsorbed on the exterior surface of the support particles while others are adsorbed in the pores. For example, using support particles having a pore size of 10 nm, a promoter of 15 nm manganese would be adsorbed on the exterior surface of the support particles, and a second promoter of 5 nm copper would be adsorbed in the pore.

Control of particle placement is also facilitated by selecting a dispersing agent based on the electro-kinetic potential (zeta potential) of a nanoparticle promoter-dispersion. Selection of a dispersing agent-promoter combination with low zeta potential will result in individual nanoparticle promoter aggregates, where attractive forces exceed repulsive forces, therefore preferably adsorbing onto the exterior surface of the support particles. Selection of a dispersing agent-promoter combination with high zeta potential will result in promoter nanoparticles repelling one another, therefore preferably adsorbing in the pore of the support particles, assuming that an individual particle has a diameter such that it fits within the pore. The carrier medium should be selected based upon its compatibility with the dispersion agent and the characteristics of the processing conditions for a given application. Under some manufacturing conditions, it may be beneficial to use a medium that easily evaporated. In other circumstances, environmental health and safety aspects may require the use of a benign carrier medium, such as water. Furthermore, the carrier medium should not be reactive with the nanoparticle promoter or support particles such that the reactivity or durability of the nanoparticle promoter decreases.

Suitable support particles are, but are not limited to, alumina, ceria, zirconia, zeolites, silica, titania, mixtures of these and other various oxides, perovskites, pillared clays, and metal-organic frameworks. The pore structures of these supports vary significantly and thus give rise to ranges in pore diameters (0.2 nm-25 nm) and pore volumes (0.1 cc/g-1.4 cc/g).

Candidates for dispersion agents include those from the chemical families having aliphatic and/or aromatic groups (methyl, ethyl, propyl, benzyl) that contain molecule endings with hydroxyl and/or amino groups, for example, silanes, siloxanes, PEGs, and polypropylene glycols (PPGs). The desirable dispersion agent composition used for a particular nanoparticle promoter may be preferably identified empirically to cause the particular promoter not to flocculate or agglomerate out of the dispersion. This stable dispersion is visually monitored during the preparation.

By adding a small quantity of water, a homogeneous slurry may be synthesized with a result in the range of 50-70% solids. The slurry may be ball-milled using bead media having a size of about 0.3 to 3 mm over a period of about 30 to 45 minutes to de-agglomerate the catalytic material. Following de-agglomeration, water may be added in stages over about 10 minutes or so, with five minutes of ball-milling employed after each stage of water being added, to obtain a solid to water ratio of about 10-20%. A homogenization step (e.g., milling) lasting 30 to 45 minutes, preferred as a method of preparing a uniform concentration, may then be conducted.

For some applications, it is preferable to form a slurry, which is generated when the diluted promoter dispersion is applied to the primary support particles. Water can be added to further dilute the dispersion solution containing 10 to 20 wt % solid nanoparticle promoter to tailor the concentration to the desired thermocatalytic application. For example, a NOx reduction catalyst dispersion may be diluted to a concentration of 1.5%, and a fuel synthesis catalyst may be diluted to 10%. These example concentrations are provided for way for demonstration and are in no way limiting. This dilution process may be followed by an additional step of homogenization for about 15 minutes or so.

The slurry may be subsequently applied to various catalyst synthesis processes to desirably position the catalyst correctly for the required thermocatalysis application. When making use of a monolithic catalyst structure, for example, the nanoparticle promoter dispersion may be diluted further to form a washcoat, which can be applied to the monolith. Optionally, additional components such as oxygen storage components and anti-sintering agents can be added to this washcoat. The dilution of the nanoparticle promoter in the washcoat may be selected based on factors such as (a) dry gain loading of the washcoat (nominal quantity of dry washcoat per physical volume of monolith) (b) final quantity of nanoparticle promoter needed (quantity per physical volume of monolith) and/or (c) type of catalyst synthesis employed.

One such process comprises, for example, taking a monolith pre-coated with promoters, oxygen storage components and anti-sintering agents and dipping this coated monolith into a diluted dispersion to obtain the desired volumetric loading of the needed nanoparticle promoters. Another example of this process comprises adding a diluted nanoparticle promoter dispersion to a wet washcoat formulation that already contains the desired base metals, oxygen storage components and anti-sintering agents, whereby the combined slurry may be homogenized and de-agglomerated to generate a final catalytic washcoat that can then be applied to a monolith. Yet another example of a process comprises adding the diluted nanoparticle promoter dispersion to a container of support particles (or combination of base metals, oxygen storage components and anti-sintering agents), where the combined material may then be formulated into a catalytic washcoat to be applied to a monolith. Other washcoat steps may be employed, depending upon the desired catalytic content and/or manufacturing efficiencies.

An advantage of the first process whereby the diluted catalytic dispersion is applied to an already-washcoated monolith is that the nanoparticle promoters are placed very close to the surface of the washcoat on the monolith. Hence, it can be good for reactions that need the nanoparticle promoter located in this fashion, for example, NOx reduction. The process of mixing the diluted catalyst directly to the washcoat and/or the washcoat components prior to application to the monolith may enjoy the advantage of placing the nanoparticle promoters more within the pores of the powders within the washcoat. For example, surface tension properties of the dispersing agent can be controlled to prevent or promote inclusion of the nanoparticle promoter into the pores of the primary support particles by capillary action or an alternative physical/chemical process. Furthermore locational control of nanoparticle promoter may be accomplished by changing the order of addition. For example, promoter dispersion may be applied to the primary support particles, or the primary support particles may be added to the promoter dispersion. These dispersion and mixing strategies may provide a better strategic location and also better thermal/hydrothermal stability. It should be noted that the choice of the process also depends on slotting the methodology into an existing manufacturing template while minimizing alterations to the existing processes, and also the economic implications of the process itself as compared to the catalytic outcome attained. For example, some manufacturers may view the latter processes—adding the diluted dispersion to the washcoat (or components) prior to application to the monolith—more expensive than a process of applying the diluted dispersion directly to a washcoated monolith. In other cases, it may be more economical.

In any case, the wet-coated monolith is then dried to eliminate most of the water from the dispersion and/or washcoat and to progress physi-sorption of the nanoparticle promoter onto the support particles. Physi-sorption is adsorption of nanoparticle promoter onto the external surface of the support particles or adsorption of promoter onto the internal pore surface of the support particles, and retaining of that particle in that location, which involves Van Der Waals forces. The coating is preferably sufficiently dry to prevent cracking of the catalyst layer and other quality issues. The monolith should be preferably at least about 85% dry. Drying preferably takes place at about 110° to 120° C.

Once dried, the monolith is preferably fired at elevated temperatures to remove organics and other undesired species (e.g., nitrates). During this step, fixing of the nanoparticle promoter through chemi-sorption is substantially completed. Chemi-sorption is when there is a chemical bond established between nano-metal particles and the support particles. The washcoat is also preferably fixed to the monolith in the firing step. Firing (calcinating) desirably occurs at 525° to 550° C. for about two to three hours.

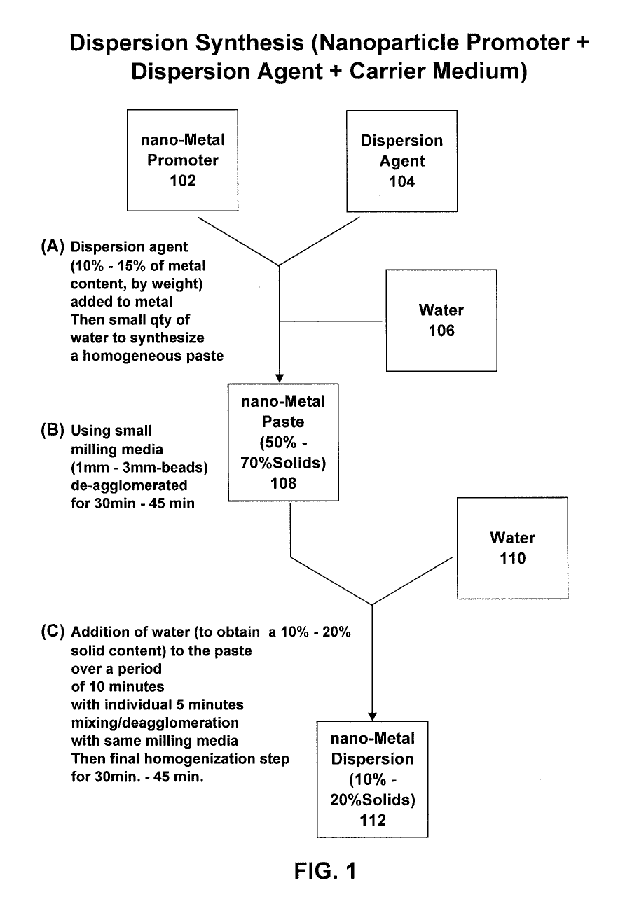

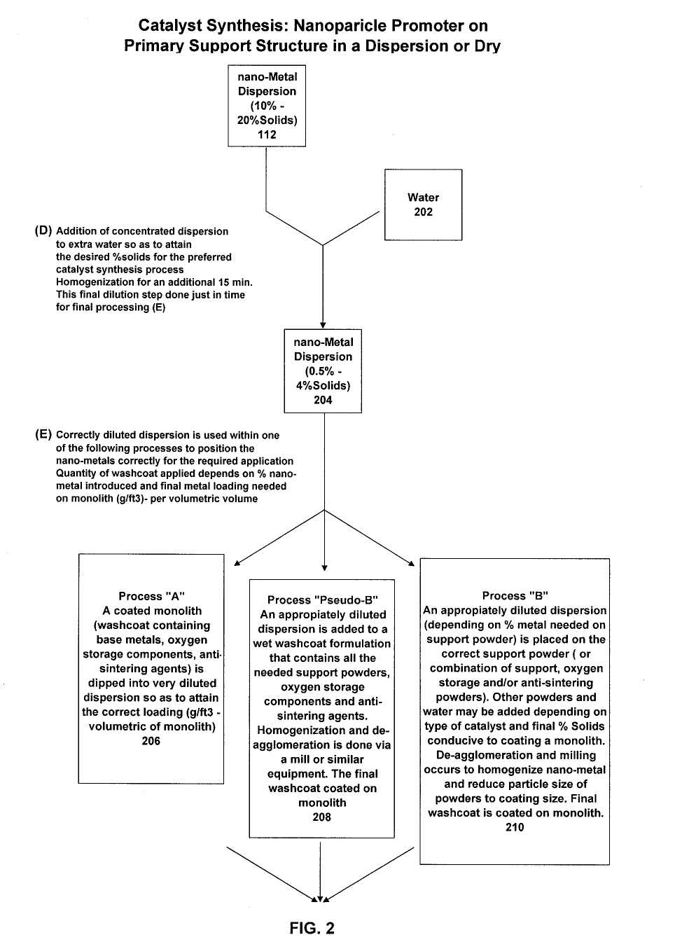

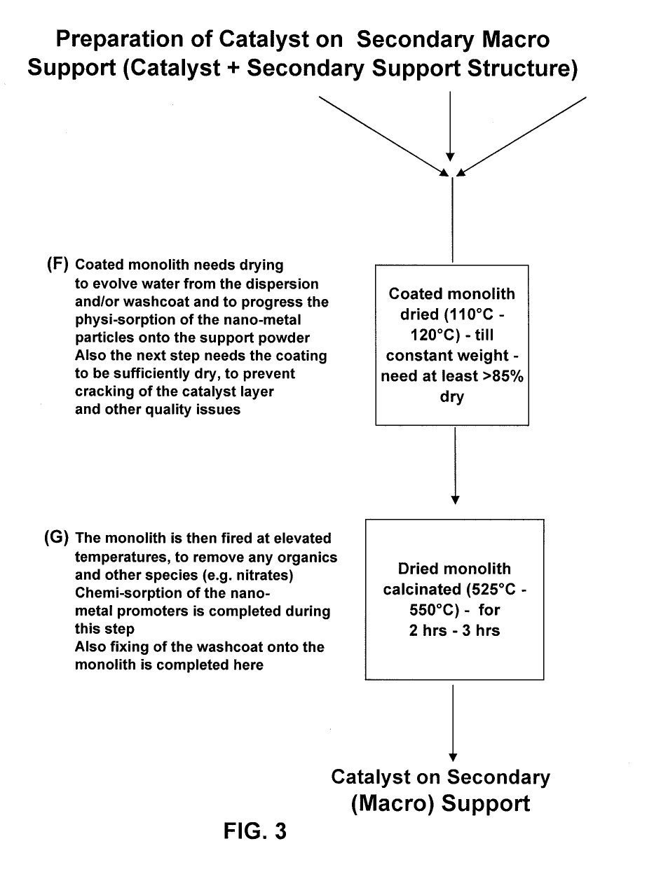

Examples of dispersion synthesis, catalyst synthesis, and preparation of catalyst on secondary macro support processes suitable for applications such as thermal catalysis can be illustrated as shown in FIG. 1, FIG. 2, and FIG. 3, respectively.

In FIG. 1, a dispersion agent 104 (for instance, 10-15% of metal content, by weight) is added to a nano-metal promoter 102. A quantity of water 106 is added to synthesize a homogeneous paste, having 50-70% solids. For instance, 2.4635 g of nano-Ag and 0.261 g of a PEG-family dispersion added can be combined and mixed with 1.5 gal of water. Using small milling media, the paste is de-agglomerated for 30-45 minutes. In the specific example described above, a nano-Ag paste as 64.5% solids results. Water 110 can then be added to the paste over a period of 10 minutes, with individual 5 minutes mixing and de-agglomeration with the above-described milling media, to obtain a paste with 10% to 20% solid content 112. Preferably, a final homogenization step is then carried out for 30 to 45 minutes. Using the nano-Ag example, for instance, a paste having 19% solids results.

In FIG. 2, the 10 to 20% solid content paste 112 is added to water 202 so as to attain a mixture with the desired percent solids for the desired catalyst synthesis process (e.g., 0.5% to 4% solids). Homogenization is conducted for an additional fifteen minutes. Referring again to the nano-Ag example, a nano-Ag mixture containing 5% solids results. The resulting mixture is used within one or more of the processes described in steps 206, 208, and 210. In one study, this mixture was added (in 3 steps) to 35 g of alumina powder (˜180 m²/g surface area and 20 nm average pore diameter). The final mixture was homogenized and dried. A portion (0.32 g) of this pre-cursor was added to oxygen storage components (2 g comprising of both ceria and zirconia (˜40 m²/g surface area, 40:60 Ce:Zr ratio) This mixture was diluted with water (5.45 g), homogenized, and milled to particle size (D90<10 μm). A small monolith core (400 CPSi, 0.5 inch diameter×1 inch length) was coated with this washcoat (1.72 g/in³ dry gain, ˜28 g/ft³ of Ag).

In FIG. 3, the resulting coated monolith is dried to evolve water from the dispersion and/or washcoat and to progress the physic-sorption of the nano-metal particles onto the support particles (powder). A sufficiently dry coating advantageously prevents cracking of the catalyst layer and other quality issues. The monolith is then fired at elevated temperatures, to remove any organics and other species (e.g., nitrates). Chemi-sorption of the nano-metal promoters and fixing of the washcoat onto the monolith is completed during this step.

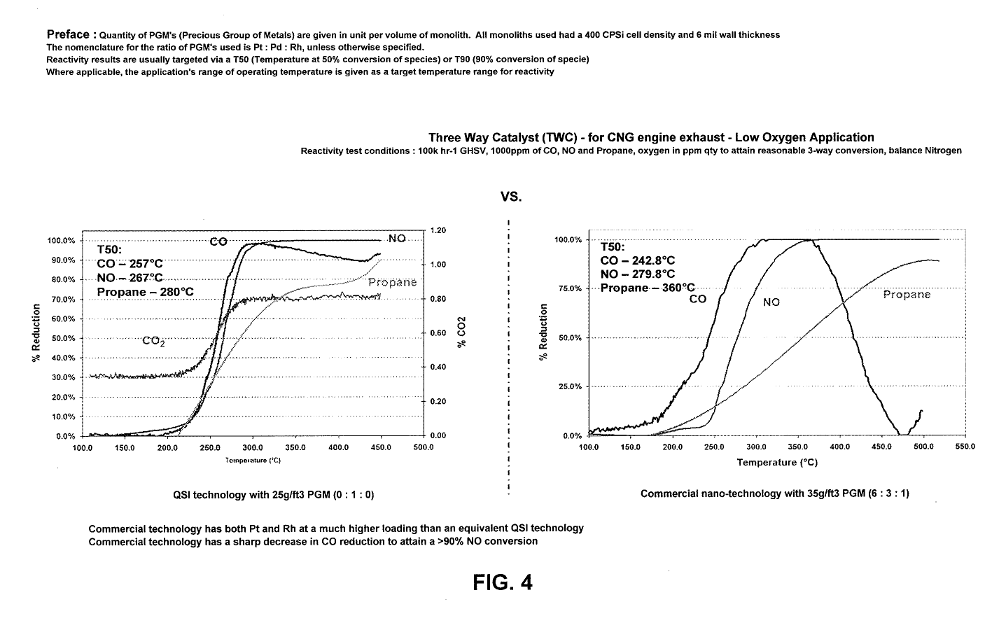

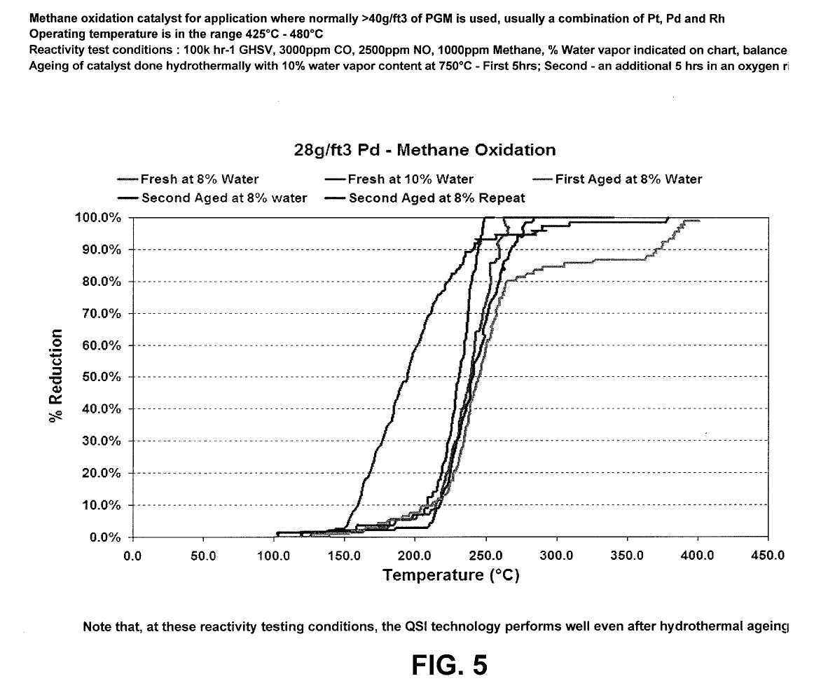

FIG. 4 compares the reactivity of the one example of catalyst of the inventive method (left) versus a commercially available catalyst (right) for a three-way catalysis reaction. FIG. 5 illustrates the reactivity and stability of one example of catalyst of the inventive method for a methane oxidation reaction.

It should be noted that various changes and modifications may be made to the above-described embodiments without departing from the spirit and scope of the inventions.

Various embodiments of the present invention include one or more of the following realizations:
(a) Small particles agglomerate during the physical catalyst synthesis process or during the normal operation of the catalyst, causing loss of surface area and activity. Making use of nanoparticle promoters with a protective oxide layer restricts agglomeration, thereby improving catalyst durability and avoiding subsequent decrease in catalytic activity.
(b) Nanoparticle promoters produced in-situ via incipient wetness impregnation method are highly susceptible to pH changes, solvent changes, and many other factors. Various embodiments of the present disclosure do not suffer from similar processing issues and can ensure better fixing of the nano-particle size. This also permits flexibility in targeting specific range of particle sizes to the particular applications;
(c) The positioning of small particles via incipient wetness impregnation method has a great number of variables to contend with (pH, concentration, type of solvent, type of support, ligand present, selective precipitation, etc.), versus the positioning of a solid nanoparticle promoter via a dispersion agent in the proper medium.
(d) Chemical processing from the promoting metal ore to the solution of the selected salt (needed to dissolve and thus form the corresponding metal ion) and further to the impregnated support, has many arduous steps that diminish the overall accountability of the metal used and potentially introduce catalytic activity and durability flaws.
(e) For multi-metal containing catalysts (e.g., a catalyst containing Pt and Pd), the impregnation of the multiple metals via incipient wetness impregnation process, needs to be done in different slurries, so that the various metal ions do not interact and cause adverse catalytic effects (e.g., Pt and Pd ions would eventually form an alloy that negates their individual catalytic properties). The use of the embodiments disclosed herein would allow the dispersion of various nano-metal promoters, without the worries of negative ionic interactions.

What is claimed is:

1. A process for physical dispersion of nanoparticle promoter on a support structure, the process comprising:
selecting a particle size distribution and chemistry for a nanoparticle promoter comprising substantially nano-sized particles;
selecting a dispersing agent to enhance dispersion of the nanoparticle promoter within a carrier medium and to control placement of the nanoparticle promoter onto selected sites of the support structure;
selecting a carrier medium that has properties to permit combining the nanoparticle promoter with the dispersion agent and carrier to form a dispersion;
creating a dispersion by combining the selected nanoparticle promoter with the carrier medium and dispersing agent;
creating a slurry by combining the dispersion with the support structure so as to achieve selective positioning of the nanoparticle promoter on the support structure;
drying the slurry to remove substantially all of the carrier medium to form a catalyst; and
calcinating the catalyst to remove the dispersion agent and any residual carrier medium, thereby fixing dispersed nanoparticles onto the site of the support.

2. The process of claim 1 wherein creating a slurry comprises adding the support structure to the dispersion, adding the dispersion to the support structure, or simultaneous adding both.

3. The process of claim 1, wherein the nanoparticle promoters comprise particles having a nominal diameter of 1 to 50 nanometers.

4. The process of claim 1, wherein the dispersing agent comprises one or more of a wetting agent or surfactant.

5. The process of claim 1, wherein the nanoparticle promoter comprise an oxide shell.

6. The process of claim 1, wherein the range of nanoparticle promoter comprises 0.1%-20%, based on dry weight of support structure.

7. The process of claim 1, wherein the dispersing agent comprises 1%-100% weight percent of the nanoparticle promoter

8. The process of claim 1, wherein the dispersing agent comprises one or more of: tri-methyl siloxane, polyethylene glycol, polyethylene oxide monoallyl ether, methy(propylhydroxide, ethoxylated) bis(trimethylsiloxy)silane, a substituted silane, or a substituted siloxane.

9. The process of claim 1, wherein the carrier medium is configured to keep the nanoparticle promoter at its primary phase or enhance the formation of its equivalent oxide, and aid the dispersion of the nanoparticle promoter for effective introduction into support.

10. The process of claim 1, wherein the carrier medium comprises water, alcohols, ketones, hexanes, olefins, or a mixture thereof

11. The process of claim 1, wherein the support comprises one or more of the following materials: alumina, ceria, zirconia, zeolites, silicas, perovskites, pillared clays, and metal organic frameworks.

12. The process of claim 1, wherein the support comprises particles having average pore diameters in the range 0.2 nm-50 nm.

13. The process of claim 1, wherein the slurry comprises support, carrier medium and promoter dispersion having a % solids range of 20%-60%.

14. The process of claim 1, further comprising adsorbing the nanoparticle promoter on or in the support by means of high shear mixing via bead mixer, ultrasound or similar technique, with a process time ranging between 5 minutes and 2 hours.

15. The process of claim 1, further comprising fixing the nanoparticle promoter onto the support by thermal means in the range of about 400° C.-600° C. for about 1 hr to 6 hrs.

16. The process of claim 1, further comprising applying the catalyst to a secondary support.

17. A process for physically dispersing nanoparticle promoters on a support structure comprising:
mixing nanoparticle promoters, a dispersion agent, and a carrier medium configured to permit combining the nanoparticle promoters with the dispersion agent and carrier to form a promoter dispersion;
combining the dispersion with a support structure to form a slurry, wherein combining comprises adding the support structure to the dispersion, adding the dispersion to the support structure, or simultaneously adding the support structure and the dispersion;
drying the slurry to remove at least a portion of the carrier medium, thereby forming a dry powder; and
calcinating the dry powder to remove remaining carrier medium and dispersion agent and to fix the dispersed nanometal onto the appropriate site of the support to form a catalyst.
